(19) United States
(12) Patent Application Publication
(10) Pub. No.: US 2025/0240706 A1
(43) Pub. Date: Jul. 24, 2025

(54) SYSTEMS, METHODS, AND DEVICES FOR WI-FI PRESENCE DETECTION

(71) Applicant: Cypress Semiconductor Corporation, San Jose, CA (US)

(72) Inventors: Sudharshan Pathi, Kadapa (IN); Aadhi Vairava Sundaram KATHALINGAM, Moutain View, CA (US); Shubham Snehalkumar Shah, Surat (IN)

(73) Assignee: Cypress Semiconductor Corporation, San Jose, CA (US)

(21) Appl. No.: 18/417,783

(22) Filed: Jan. 19, 2024

(51) Int. Cl. H04W 48/16; H04W 72/02; H04W 72/563; H04W 84/12

(52) U.S. Cl. CPC H04W 48/16; H04W 72/02; H04W 72/563; H04W 84/12

(57) ABSTRACT

Systems, methods, and devices provide radar detection in wireless devices. Methods include determining wireless connection data for a wireless communications link, and generating a plurality of wireless connection metrics based on the wireless connection data. Methods also include generating a selection of one or more of a plurality of subcarriers based, at least in part, on the plurality of wireless connection metrics, and generating a determination of a presence event based, at least in part, on the selection of the one or more subcarriers.

### TECHNICAL FIELD

This disclosure relates to wireless devices, and more specifically, to enhancement of detection of the presence of entities using such wireless devices.

### BACKGROUND

Wireless detection of entities, such as people within an operational environment of wireless devices, may utilize various radar modalities. For example, radiofrequency (RF) equipment may be utilized for radar-based detection of such entities. Accordingly, when an entity, such as a user, enters within a designated range, such radar modalities may be used to detect the entity based on reflected RF signals. Conventional techniques for performing such entity detection remain limited because they utilize additional hardware resource for such RF detection, and they additionally use resources to process large amounts of data.

### BRIEF DESCRIPTION OF THE DRAWINGS

FIG. 1 illustrates an example of a system for presence detection using wireless devices, configured in accordance with some embodiments.

FIG. 2 illustrates another example of a device for presence detection using wireless devices, configured in accordance with some embodiments.

FIG. 3 illustrates an example of a method for presence detection using wireless devices, performed in accordance with some embodiments.

FIG. 4 illustrates an additional example of a method for presence detection using wireless devices, performed in accordance with some embodiments.

FIG. 5 illustrates another example of a method for presence detection using wireless devices, performed in accordance with some embodiments.

FIG. 6 illustrates an additional example of a method for presence detection using wireless devices, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless environments may include a variety of wireless devices that may communicate with each other via one or more communications links. Accordingly, such wireless devices may communicate with each other in accordance with a wireless communications protocol, such as a Wi-Fi protocol. Conventional techniques for implementing such wireless environments remain limited because they are not able to detect entities within such wireless environments without the usage of additional RF equipment for radar-based detection modalities.

Embodiments disclosed herein provide the ability to detect entities within a wireless environment in an efficient manner that reduces hardware resources and computational resources. More specifically, wireless connection data of wireless communications links may be used to infer the presence of an entity within the wireless environment, and thus detect the presence of a user without the use of additional RF equipment. Moreover, as will be discussed in greater detail below, the wireless connection data may be filtered to reduce an amount of data used to make such determinations, and thus reduce processing resources used for such determinations.

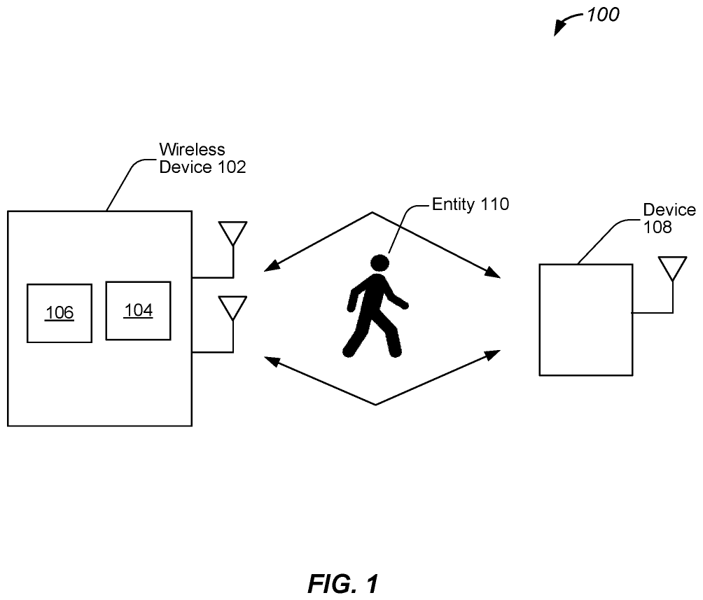

FIG. 1 illustrates an example of a system for presence detection using wireless devices, configured in accordance with some embodiments. Accordingly, a system, such as system 100, may include wireless devices that are used for wireless communications, and are also configured to be able to detect the presence of one or more entities using wireless communications channels associated with such wireless devices. As will be discussed in greater detail below, wireless devices included in system 100 may be configured to use various wireless connection metrics to make such determinations in a power-efficient manner.

In some embodiments, system 100 includes wireless device 102 which is configured to transmit and receive wireless signals in accordance with one or more communications protocols. For example, wireless device 102 may include one or more transceivers, such as transceiver 104, which is configured to transmit and receive signals in accordance with a wireless communications protocol, such as a Wi-Fi protocol. In various embodiments, wireless device 102 additionally includes a processing device, such as processing device 106, which is configured to implement various hardware and logic associated with transceiver 104, and its associated wireless communications protocol. For example, processing device 106 may be configured to implement a medium access control (MAC) layer that is configured to control hardware associated with a wireless transmission medium, such as that associated with a Wi-Fi transmission medium.

In various embodiments, wireless device 102 is within communications range of one or more devices or entities. In one example, wireless device 102 is within range of device 108, which may be another wireless device. Accordingly, device 108 may also include a transceiver and associated processing logic configured to facilitate wireless communications in accordance with a wireless communications protocol, such as a Wi-Fi protocol. Thus, wireless device 102 may be configured to establish a wireless connection with device 108, and transmit and receive data packets from device 108. In one example, wireless device 102 may be configured as a central device, such as an access point, and device 108 may be configured as a peripheral device, such as a station.

Moreover, wireless device 102 is also in range of entity 110. As shown in FIG. 1, entity 110 may be a person (not shown to scale). As will be discussed in greater detail below, wireless device 102 is configured to infer the presence of entity 110 based on changes in features of wireless communications channels that may be used to communicate with devices, such as device 108. In this way, system 100 may support wireless communication as well as presence event detection associated with entities, such as humans.

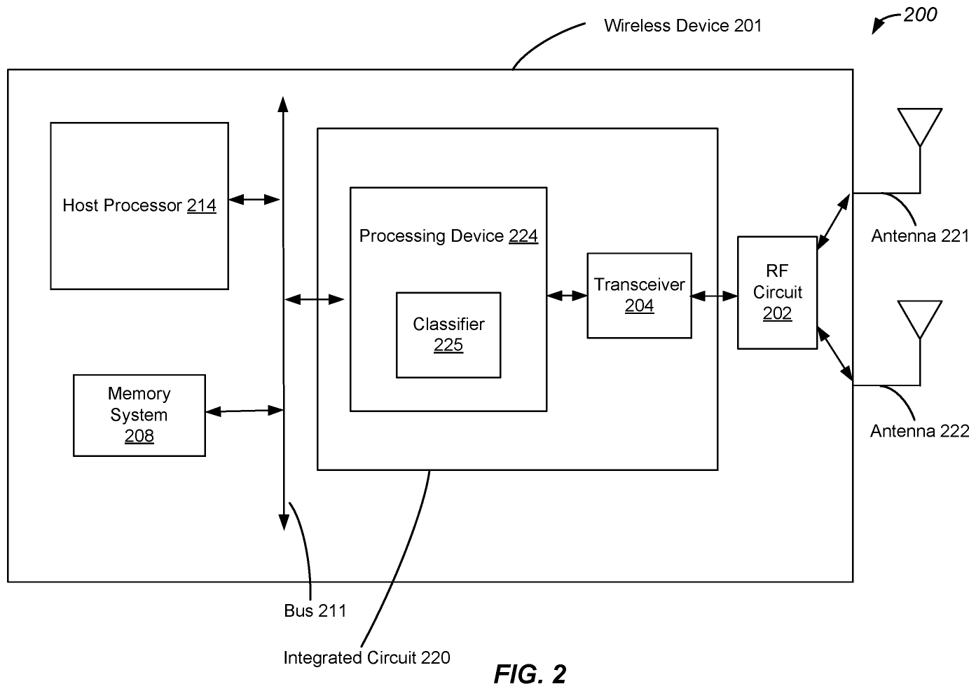

FIG. 2 illustrates another example of a device for presence detection using wireless devices, configured in accordance with some embodiments. More specifically, FIG. 2 illustrates an example of a system, such as system 200, that may include wireless device 201. It will be appreciated that wireless device 201 may be one of any of the wireless devices discussed above with reference to FIG. 1, such as wireless device 102 and device 108.

In various embodiments, wireless device 201 includes one or more transceivers, such as transceiver 204. In one example, system 200 includes transceiver 204 which is configured to transmit and receive signals using a communications medium that may include antenna 221 or antenna 222. As noted above, transceiver 204 may be a Wi-Fi transceiver. Accordingly, transceiver 204 may be compatible with a Wi-Fi communications protocol. In various embodiments, transceiver 204 includes a modulator and demodulator as well as one or more buffers and filters, that are configured to generate and receive signals via antenna 221 and/or antenna 222.

In various embodiments, system 200 further includes one or more processing devices, such as processing device 224 which may include logic implemented using one or more processor cores. Accordingly, processing device 224 is configured to implement logic for presence detection operations, as will be discussed in greater detail below. For example, processing device 224 may be configured to use wireless connection metrics, which may include channel state information, to infer the presence of one or more entities within a wireless communications range of wireless device 201. More specifically, processing device 224 may include classifier 225 that includes processing elements configured to perform presence detection operations, as will be discussed in greater detail below. In one example, classifier 225 may be logic implemented in firmware.

Accordingly, processing device 224 includes processing elements configured to perform wireless communication operations as well as presence detection operations.

Processing device 224 includes one or more components configured to implement a media access control (MAC) layer that is configured to control hardware associated with a wireless transmission medium, such as that associated with a Wi-Fi transmission medium. In one example, processing device 224 may be configured to implement a driver, such as a Wi-Fi driver. Accordingly, processing device 224 may include components associated with transceiver 204, such as MAC layers, packet traffic arbiters, and a scheduler.

System 200 further includes radio frequency (RF) circuit 202 which is coupled to antenna 221 and antenna 222. In various embodiments, RF circuit 202 may include various components such as an RF switch, a diplexer, and a filter. Accordingly, RF circuit 202 may be configured to select an antenna for transmission/reception, and may be configured to provide coupling between the selected antenna, such as antenna 221 or antenna 222, and other components of system 200 via a bus, such as bus 211. While one RF circuit is shown, it will be appreciated that wireless device 201 may include multiple RF circuits. Accordingly, each of multiple antennas may have its own RF circuit.

System 200 includes memory system 208 which is configured to store one or more data values associated with presence detection operations discussed in greater detail below. Accordingly, memory system 208 includes storage device, which may be a non-volatile random-access memory (NVRAM) configured to store such data values, and may also include a cache that is configured to provide a local cache. In various embodiments, system 200 further includes host processor 214 which is configured to implement processing operations implemented by system 200.

It will be appreciated that one or more of the above-described components may be implemented on a single chip, or on different chips. For example, transceiver 204 and processing device 224 may be implemented on the same integrated circuit chip, such as integrated circuit chip 220. In another example transceiver 204 and processing device 224 may each be implemented on their own chip, and thus may be disposed separately as a multi-chip module or on a common substrate such as a printed circuit board (PCB). It will also be appreciated that components of system 200 may be implemented in a variety of context, such as the context of a smart home environment or a wireless environment including Internet of Things (IoT) devices.

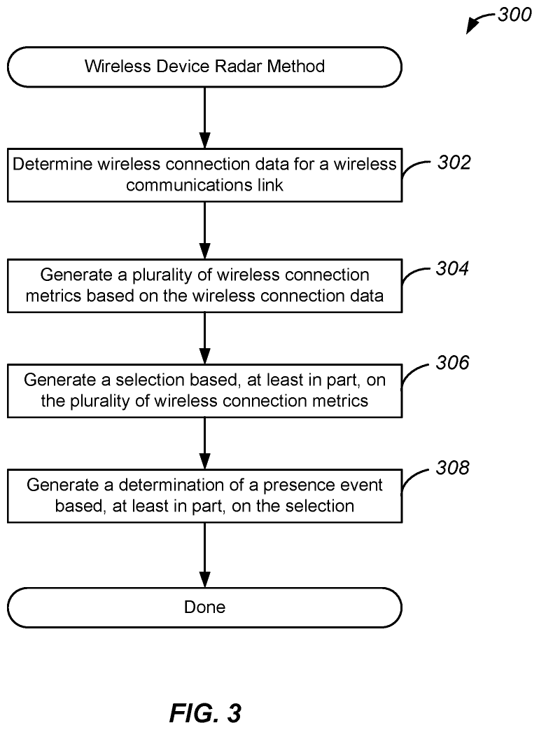

FIG. 3 illustrates an example of a method for presence detection using wireless devices, performed in accordance with some embodiments. Accordingly, a method such as method 300 may be performed to detect the presence of one or more entities using wireless communications channels associated with such wireless devices. As will be discussed in greater detail below, various wireless connection metrics may be used to make such determinations in a power-efficient manner.

Method 300 may perform operation 302 during which wireless connection data may be determined for a wireless communications link. In various embodiments, the wireless connection data may include information about a wireless connection between a central wireless device and a peripheral wireless device. In some embodiments, the central wireless device may be a wireless device as similarly discussed above with reference to FIG. 1 and FIG. 2. For example, the wireless connection data may include a listing of all subcarriers within the wireless band used for the wireless information. The wireless connection data may also include channel state information for each of the subcarriers, as determined in accordance with a Wi-Fi protocol.

Method 300 may perform operation 304 during which a plurality of wireless connection metrics may be generated based on the wireless connection data. Accordingly, one or more metrics may be computed for each subcarrier of the wireless connection. As will be discussed in greater detail below, the wireless connection metrics may include signal quality metrics and/or environmental metrics representing ambient conditions affecting data transmission.

Method 300 may perform operation 306 during which a selection may be made based, at least in part, on the plurality of wireless connection metrics. In various embodiments, the subcarriers may be sorted and filtered based on the wireless connection metrics. Moreover, a designated number of the subcarriers may be selected based on the wireless connection metrics. In this way, a selection may be made that includes a sub-set of the subcarriers, and the sub-set may be selected based on their wireless connection metrics.

Method 300 may perform operation 308 during which a determination of a presence event may be generated based, at least in part, on the selection. In various embodiments, a presence event may be a determination that an entity is present and has been detected at a wireless device. As will be discussed in greater detail below, variances in the wireless connection metrics may be used to identify a presence event. More specifically, such variances in the wireless connection metrics may be used to infer the presence of an entity, such as a person, within a communications range of the central wireless device. In this way, wireless connection metrics for a connection between a central wireless device and a peripheral wireless device may be used to determine if an entity, such as a person, is present within a wireless environment of the central wireless device.

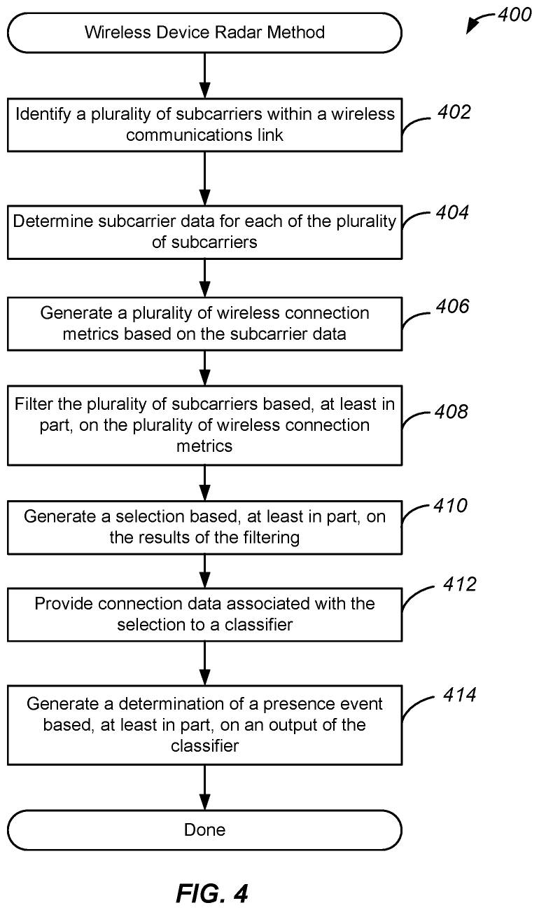

FIG. 4 illustrates an additional example of a method for presence detection using wireless devices, performed in accordance with some embodiments. Accordingly, a method such as method 400 may be performed to detect the presence of one or more entities using wireless communications channels associated with such wireless devices. As will be discussed in greater detail below, various wireless connection metrics may be used to make such determinations in a power-efficient manner.

Method 400 may perform operation 402 during which a plurality of subcarriers may be identified within a wireless communications link. In various embodiments, the plurality of subcarriers may include all subcarriers included in the wireless communications link between wireless devices such as a central wireless device and a peripheral wireless device. In some embodiments, the central wireless device may be a wireless device as similarly discussed above with reference to FIG. 1 and FIG. 2. More specifically, a frequency band used for a communications channel of the communications link may be partitioned into various different subcarriers, and information identifying each of the subcarriers may be stored by the wireless devices. Accordingly, during operation 402, such information may be retrieved.

Method 400 may perform operation 404 during which subcarrier data may be determined for each of the plurality of subcarriers. In various embodiments, the subcarrier data may include channel state information that provides information, such as quality metrics, about each subcarrier for a connection between the central wireless device and the peripheral wireless device. For example, the channel state information may include physical channel measurements at a subcarrier-level as may be performed in accordance with a Wi-Fi standard. In various embodiments, the Wi-Fi standard may be an IEEE 802.11 standard such as 802.11n, 802.11ac, 802.11ax, 802.11be, or any other suitable standard. Accordingly, during operation 404, such channel state information may be determined for each of the plurality of subcarriers. In one example, such channel state information may be determined based on a transmission of a plurality of beacon frames from the central wireless device.

Method 400 may perform operation 406 during which a plurality of wireless connection metrics may be generated based on the subcarrier data. Accordingly, one or more wireless connection metrics may be computed for each subcarrier of the wireless connection, and such wireless connection metrics may include signal quality metrics and/or environmental metrics representing ambient conditions affecting data transmission.

In one example, the wireless connection metric may be representative of scattering of the Wi-Fi signal due to environmental factors, such as the presence of one or more entities in the wireless communication area, as discussed above with reference to FIG. 1. Accordingly, such a wireless connection metric may be computed based on a comparison of an input signal and output signal. For example, a wireless connection metric may be computed using equation 1 shown below:

$$H = \frac{Y}{X} \qquad ( 1 )$$

In equation 1, X may be an input included in a data packet when transmitted, Y may be an output included in the data packet when received, and H may be a metric that represents how much scattering from environmental factors has affected the input/output relationship. In one example, X may be a long training field (LTF), and Y may be determined based on a received signal. As indicated above, H may be determined based on their ratio. It will be appreciated that the ratio of any suitable feature of data packets associated with X and Y may be taken. For example, the ratio may be of their signal strength metrics or some other spectrum power indicator. In such an example, the value associated with X may be a designated reference value.

Method 400 may perform operation 408 during which the plurality of subcarriers may be filtered based, at least in part, on the plurality of wireless connection metrics. Accordingly, once the wireless connection metrics have been determined for the subcarriers, the subcarriers may be filtered to remove one or more outliers. In one example, Hampel filtering may be applied to the subcarriers based on the wireless connection metrics.

Method 400 may perform operation 410 during which a selection may be generated based, at least in part, on the results of the filtering. In various embodiments, the subcarriers may be sorted based on the wireless connection metrics. More specifically, the subcarriers may be ranked based on the wireless connection metrics. For example, the ranking may be based on the H metrics discussed above. Moreover, a designated number of the subcarriers may be selected based on the wireless connection metrics, out of, for example, 234 available subcarriers. In this way, a sub-set of the subcarriers may be selected based on their wireless connection metrics.

Method 400 may perform operation 412 during which connection data associated with the selection may be provided to a classifier. Accordingly, wireless connection metrics for the selected sub-set of subcarriers may be provided to the classifier to determine if there is a presence event. In this way, a reduced data set is provided to the classifier, and presence event detection may be performed more efficiently.

Method 400 may perform operation 414 during which a determination of a presence event may be generated based, at least in part, on an output of the classifier. In various embodiments, variances in the wireless connection metrics may be used to identify a presence event. More specifically, such variances in the wireless connection metrics may be used to infer the presence of an entity, such as a person, within a communications range of the central wireless device. As will be discussed in greater detail below, wireless connection metrics for a connection between a central wireless device and a peripheral wireless device may be used to determine if an entity, such as a person, is present within a wireless environment of the central wireless device.

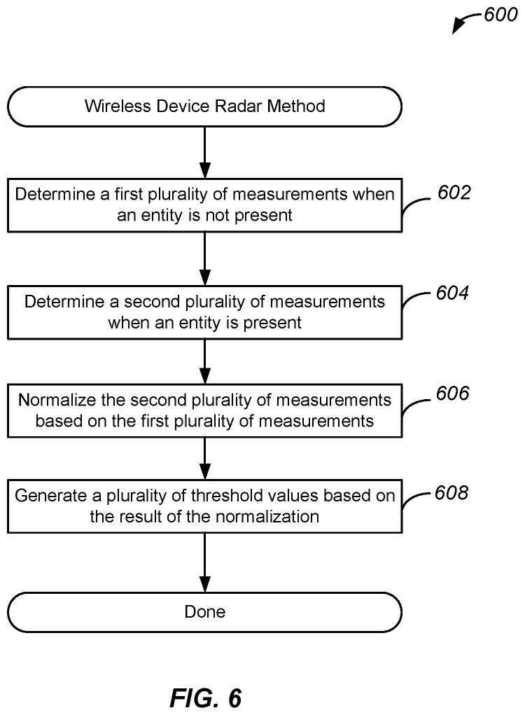

While FIG. 4 illustrates one iteration of method 400, it will be appreciated that additional iterations may be performed based on and in response to changes in ambient and/or operational conditions. For example, changes in the wireless environment may result in changes in signal attenuation between a central wireless device and a peripheral wireless device. Such signal attenuation may identified based on one or more signal quality metrics between the wireless devices. Accordingly, in response to detecting a signal attenuation, one or more calibration operations may be performed, such as those described below with reference to FIG. 6. In some embodiments, such calibration operations may be performed periodically. In this way, the determination of presence events may be performed in an adaptive manner that dynamically compensates for changes in wireless environments and associated signal attenuations.

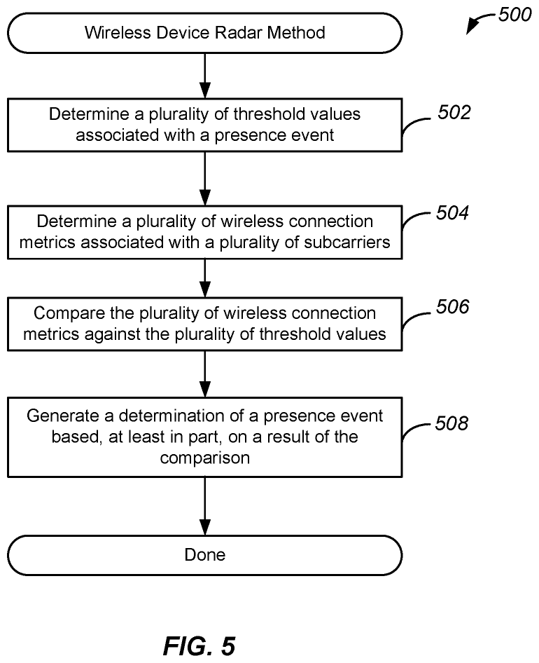

FIG. 5 illustrates another example of a method for presence detection using wireless devices, performed in accordance with some embodiments. Accordingly, a method such as method 500 may be performed to detect the presence of one or more entities using wireless communications channels associated with such wireless devices. As will be discussed in greater detail below, a classifier, which may be implemented in a wireless device, may perform method 500 to make such detection determinations.

Method 500 may perform operation 502 during which a plurality of threshold values associated with a presence event may be determined. As will be discussed in greater detail below with reference to FIG. 6, a plurality of threshold values may be determined during one or more calibration operations, and may be stored in memory. Accordingly, during operation 502, such threshold values may be retrieved from memory.

Method 500 may perform operation 504 during which a plurality of wireless connection metrics associated with a plurality of subcarriers may be determined. As discussed above, the wireless connection metrics may be generated based on subcarrier data for a plurality of subcarriers. Accordingly, during operation, such wireless connection metrics may be generated, or may be retrieved from memory if they have previously been generated. As similarly discussed above, the wireless connection metrics may be determined for a sub-set of subcarriers, and thus include a smaller dataset than that associated with the entire

Method 500 may perform operation 506 during which the plurality of wireless connection metrics may be compared against the plurality of threshold values. Accordingly, the wireless connection metrics may be compared against the threshold values to determine if the wireless connection metrics are greater than or less than the threshold values. In some embodiments, a threshold crossing may be identified during operation 506.

Method 500 may perform operation 508 during which a determination of a presence event may be generated based, at least in part, on a result of the comparison. Thus, according to some embodiments, the comparison of the wireless connection metrics to the threshold values may be used to infer the presence of an entity within the wireless environment. For example, the wireless connection metrics for the sub-set of subcarriers falling below their associated designated threshold values may be used to identify the presence of an entity, such as a user, and generate an indication of a detection of a presence event. Such an indication of a presence event may be transmitted to another component of the wireless device, or may be communicated to another wireless device within the wireless environment.

It will be appreciated that a composite analysis of the wireless connection metrics may be used to identify a presence event. For example, a threshold crossing for a designated number of the sub-set of carriers, such as greater than half or two-thirds, may be used to identify a presence event. In various embodiments, subcarriers are selected based on variance of H metrics, and thresholds are determined based on amplitude and phase variances. In some embodiments, a multiplication or scaling factor may also be used.

FIG. 6 illustrates an additional example of a method for presence detection using wireless devices, performed in accordance with some embodiments. As will be discussed in greater detail below, a method such as method 600 may be performed to calibrate parameters used to detect the presence of one or more entities using wireless communications channels associated with such wireless devices. More specifically, one or more calibration operations may be performed to calibrate a wireless device to sense the presence of an entity, such as a person, within a wireless environment of the wireless device. In some embodiments, method 600 may be performed by an entity, such as a manufacturer, designer, administrator, or user, and may be performed during a calibration phase. In some embodiments, method 600 may be performed periodically and/or dynamically by the wireless device in response to detecting one or more environmental or operational conditions.

Method 600 may perform operation 602 during which a first plurality of measurements may be determined when an entity is not present. Accordingly, a first plurality of measurements may be made at a central wireless device, and the first plurality of measurements may include channel state information for a plurality of subcarriers, as similarly discussed above. In this way, the first plurality of measurements includes data that describes signal scattering in the wireless environment when no entity is present.

Method 600 may perform operation 604 during which a second plurality of measurements may be determined when an entity is present. Accordingly, a second plurality of measurements may be made at the central wireless device that includes channel state information, as similarly discussed above. More specifically, the second plurality of measurements includes data that describes signal scattering in the wireless environment when one or more entities are present. In this way, different sets of measurements may be made for different environmental configurations of entities within the wireless environment.

Method 600 may perform operation 606 during which the second plurality of measurements may be normalized based on the first plurality of measurements. Accordingly, the first plurality of measurements may be used as a baseline for normalization of the second plurality of measurements, and the normalized data may be used for threshold value generation, as will be discussed in greater detail below. In various embodiments, the normalization operation reduces variability in threshold values between subcarriers.

Method 600 may perform operation 608 during which a plurality of threshold values may be generated based on the result of the normalization. More specifically, the plurality of threshold values may be generated by applying a designated scaling factor to the normalized results. For example, the normalized measurements may be multiplied by a designated scaling factor to generate a threshold value that has a designated difference value from the normalized measurement. In one example, multiplying a normalized measurement by a designated scaling factor of “0.9” may generate a threshold value that is 90 percent of the normalized measurement. In various embodiments, the designated scaling factor is determined by an entity, such as a manufacturer.

In some embodiments, the plurality of threshold values may identify values of wireless connection metrics that may correspond to different determined states. For example, a plurality of threshold values may identify a threshold value for the wireless connection metric where it may be determined that an entity is present within the wireless environment. In one example, if the wireless connection metric is greater than the threshold value, it may be determine that no entity is present. Moreover, if the wireless connection metric is less than the threshold value, it may be determine that no entity is present.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
determining wireless connection data for a wireless communications link;
generating a plurality of wireless connection metrics based on the wireless connection data;
generating a selection of one or more of a plurality of subcarriers based, at least in part, on the plurality of wireless connection metrics; and
generating a determination of a presence event based, at least in part, on the selection of the one or more subcarriers.

2. The method of claim 1, wherein the wireless connection data comprises channel state information for each subcarrier of the wireless communications link.

3. The method of claim 2, wherein the plurality of wireless connection metrics comprise one or more environmental metrics.

4. The method of claim 1, wherein the generating of the selection further comprises:
filtering the one or more subcarriers based, at least in part, on the wireless connection data.

5. The method of claim 4, wherein the filtering further comprises:
ranking the one or more subcarriers based, at least in part, on the wireless connection data.

6. The method of claim 1, wherein the generating of the determination of the presence event further comprises:
comparing wireless connection data of the selection of the one or more subcarriers with a plurality of designated threshold values.

7. The method of claim 6 further comprising:
determining the plurality of designated threshold values based on one or more calibration operations.

8. The method of claim 7, wherein the one or more calibration operations comprise:
determining a first plurality of measurements via the wireless communications link when an entity is not present; and
determining a second plurality of measurements via the wireless communications link when an entity is present.

9. The method of claim 8 further comprising:
generating the plurality of designated threshold values based on a comparison of the first plurality of measurements and the second plurality of measurements.

10. A system comprising:
a transceiver configured to establish a wireless communications link compatible with a wireless communications protocol; and
a processing device configured to:
determine wireless connection data for the wireless communications link;
generate a plurality of wireless connection metrics based on the wireless connection data;
generate a selection of one or more subcarriers based, at least in part, on the plurality of wireless connection metrics; and
generate a determination of a presence event based, at least in part, on the selection of the one or more subcarriers.

11. The system of claim 10, wherein the wireless connection data comprises channel state information for each subcarrier of the wireless communications link.

12. The system of claim 11, wherein the plurality of wireless connection metrics comprise one or more environmental metrics.

13. The system of claim 10, wherein the processing device is further configured to:
filter the one or more subcarriers based, at least in part, on the wireless connection data.

14. The system of claim 10, wherein the processing device is further configured to:
compare wireless connection data of the selection of the one or more subcarriers with a plurality of designated threshold values.

15. The system of claim 14, wherein the processing device is further configured to:
determine the plurality of designated threshold values based on one or more calibration operations.

16. A device comprising:
processing elements configured to:
determine wireless connection data for a wireless communications link;
generate a plurality of wireless connection metrics based on the wireless connection data;
generate a selection of one or more subcarriers based, at least in part, on the plurality of wireless connection metrics; and
generate a determination of a presence event based, at least in part, on the selection of the one or more subcarriers.

17. The device of claim 16, wherein the wireless connection data comprises channel state information for each subcarrier of the wireless communications link.

18. The device of claim 17, wherein the plurality of wireless connection metrics comprise one or more environmental metrics.

19. The device of claim 16, wherein the processing elements are further configured to:
filter the one or more subcarriers based, at least in part, on the wireless connection data.

20. The device of claim 16, wherein the processing elements are further configured to:
compare wireless connection data of the selection of the one or more subcarriers with a plurality of designated threshold values.
